(19) United States
(12) Patent Application Publication
(10) Pub. No.: US 2012/0330748 A1
(43) Pub. Date: Dec. 27, 2012

(54) UNIVERSALLY TARGETING ONLINE ADVERTISEMENTS

(75) Inventors: MANSOOR A. MALIK, Bothell, WA (US); WOOK JIN CHUNG, Sunnyvale, CA (US)

(73) Assignee: MICROSOFT CORPORATION, Redmond, WA (US)

(21) Appl. No.: 13/169,857

(22) Filed: Jun. 27, 2011

(51) Int. Cl. G06Q 30/00

(52) U.S. Cl. 705/14.53; 705/14.55

(57) ABSTRACT

Systems, methods, and computer-readable media for communicating advertisement preferences configured by users to a plurality of network domains that serve advertisements are provided. Users input their preferences with respect to advertisement targeting through a common interface and those preferences are communicated to a plurality of network domains in conjunction with requests for advertisements. In this way, users do not have to submit their preferences for advertisement targeting independently for each network domain that serves advertisements and advertisement-serving network domains have a decreased risk of having outdated or incomplete advertisement targeting information.

### BACKGROUND

Today, users shopping for commodities online often try to look for a “deal” or an online advertisement or coupon for the item they wish to purchase. As such, it is a goal of advertisers to present relevant and targeted advertisements to users. It is also of interest to users to be presented with the right advertisements at the right time when they are online.

To aid in achieving these objectives, network domains that serve advertisements attempt to log behavior and interests implicitly as users browse through sites (e.g., via the browser or click activities) and/or explicitly by soliciting survey or interest-based form responses from users. However, this data is specific to each individual network domain that logs it and, as such it can easily become stale if a user does not access a particular network domain for a period of time. An additional challenge for network domains that serve advertisements is that targeting information simply may not be available for some users.

Challenges from the user's perspective also exist. For instance, users often do not have an easy way to return to a survey or interest-based form for each different network domain to update their interests as they change, for instance, based on a purchase or interest in a new item. Additionally, users who wish to opt-out of receiving targeted advertisements (e.g., for privacy concerns or the like) must opt-out individually for each network domain—a task that may be nearly impossible for a user to accomplish. Further, even if a user managed to opt-out of receiving targeted advertisements for all network domain serving advertisements, if s/he then wanted to opt back in, all of the user's previous history would be lost. Thus, receiving targeted advertisements in the way to which the user was previously accustomed would not take place, not to mention the serving network domains would have lost the data necessary to serve advertisements that have a high likelihood of being of interest to the user.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable media for, among other things, communicating advertisement preferences configured by users via a unified interface to a plurality of network domains that serve advertisements. Users input their preferences with respect to advertisement targeting through a common interface and those preferences are communicated to a plurality of network domains in conjunction with requests for advertisements. In this way, users do not have to submit their preferences for advertisement targeting independently for each network domain that serves advertisements and advertisement-serving network domains have a decreased risk of having outdated or incomplete advertisement targeting information. Additionally, users have the ability to opt-out of receiving targeted advertisements from a plurality of network domains that serve advertisements via a single unified interface. And, if a user desires to opt-out only temporarily, opting back in may be achieved through a single unified interface for a plurality of advertisement-serving domains and with the user's previous history preserved.

### BRIEF DESCRIPTION OF THE DRAWINGS

The present invention is illustrated by way of example and not limited in the accompanying figures in which like reference numerals indicate similar elements and in which:

FIG. 1 is a block diagram of an exemplary computing environment suitable for use in implementing embodiments of the present invention;

FIG. 2 is a block diagram of an exemplary computing system in which embodiments of the invention may be employed;

FIG. 3 is a flow diagram showing a method for communicating user-configured advertisement preferences to a plurality of network domains that serve advertisements, in accordance with an embodiment of the present invention; and

FIG. 4 is a flow diagram showing a method for presenting targeted advertisements to online users, in accordance with another embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable media for, among other things, communicating advertisement preferences configured by users via a unified interface to a plurality of network domains that serve advertisements. Users input their preferences with respect to advertisement targeting through a common interface and those preferences are communicated to a plurality of network domains in conjunction with requests for advertisements. In this way, users do not have to submit their preferences for advertisement targeting independently for each network domain that serves advertisements, and advertisement-serving network domains have a decreased risk of having outdated or incomplete advertisement targeting information.

Having unified advertisement-preference data for all network domains that serve advertisements aids in positively synergizing the user-advertiser-advertising network ecosystem. Network domains serving advertisements will not need to be as focused on capturing user behavior data but rather more on ensuring that the user-configured advertisement preferences are respected. Advertisers will be able to find the user they really want to target with fewer false positives and focus more on delivering the right marketing message and advertisement content to the right set of audiences. Lastly, users will be empowered to express themselves of interests, demographics, and the like, for getting significantly better advertisements throughout their Internet experience.

Accordingly, one embodiment of the present invention is directed to one or more computer-readable storage media storing computer-useable instructions that, when used by one or more computing devices, cause the one or more computing devices to perform a method for communicating user-configured advertisement preferences to a plurality of network domains that serve advertisements. The method includes receiving user-configured advertisement-preference data configured for use by the plurality of network domains for selecting targeted advertisements, receiving a request for an advertisement, automatically adding the user-configured advertisement-preference data to a communication packet, and serving the communication packet with the user-configured advertisement-preference data added thereto to at least a portion of the plurality of network domains in response to the advertisement request

Another embodiment of the present invention is directed to a one or more computer-readable storage media storing computer-useable instructions that, when used by one or more computing devices, cause the one or more computing devices to perform a method for presenting targeted advertisements to online users. The method includes receiving a request for an advertisement, the request including advertisement-preference data configured by a user, selecting at least one advertisement targeted to the user utilizing the advertisement-preference data, and transmitting the selected at least one advertisement for presentation to the user.

In yet another embodiment, the present invention is directed to a unified advertisement targeting system configured for use by a plurality of network domains that serve advertisements. The system includes a computing device associated with one or more processors and one or more computer-readable storage media, a data store coupled with the computing device, and a browser. The browser is configured to receive user-configured advertisement-preference data configured for use by the plurality of network domains for selecting targeted advertisements, receive a request for an advertisement, automatically add the user-configured advertisement-preference data to a communication packet, serve the communication packet with the user-configured advertisement-preference data added thereto to at least a portion of the plurality of network domains in response to the advertisement request, receive at least one advertisement targeted in accordance with the user-configured advertisement-preference data from one of the plurality of network domains that serves advertisements, and present the targeted advertisement.

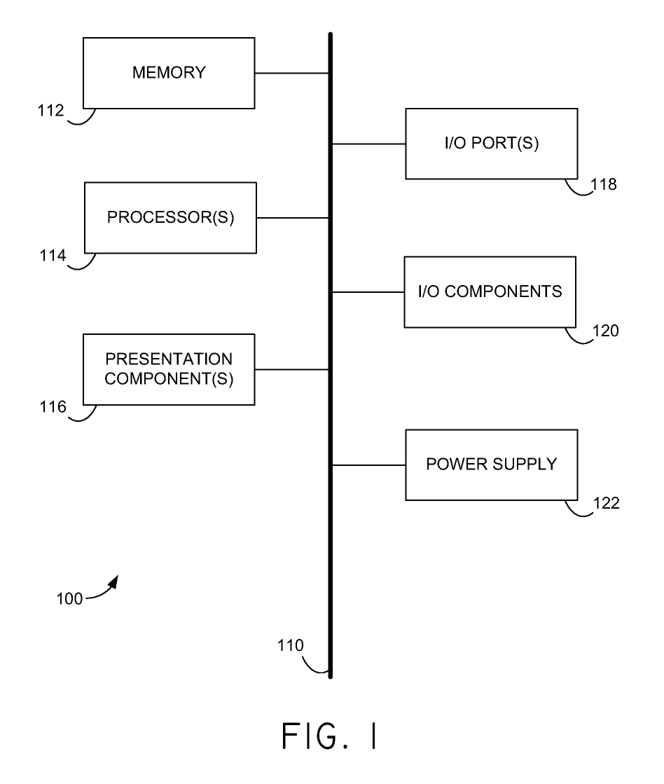

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media can be any available media that can be accessed by the computing device 100 and includes both volatile and nonvolatile media, removable and non-removable media implemented in any method or technology for storage of information such as computer-readable instructions, data structures, program modules or other data. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, and the like.

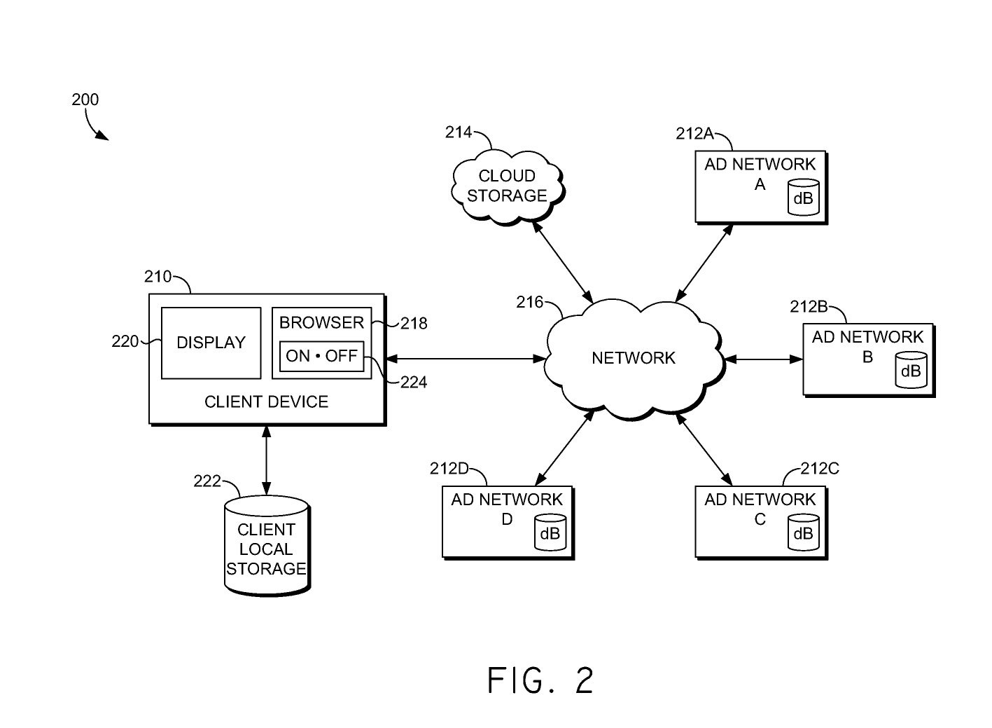

Referring now to FIG. 2, a block diagram is provided illustrating an exemplary computing system 200 in which embodiments of the present invention may be employed. Generally, the computing system 200 illustrates an environment in which advertisement preferences configured by users via a unified interface are communicated to a plurality of network domains that serve advertisements. Accordingly, as will be described in further detail below, embodiments of the present invention provide systems, methods, and computer-readable media for permitting users to input their preferences with respect to advertisement targeting through a common interface and have those preferences communicated to a plurality of network domains in conjunction with requests for advertisements.

Among other components not shown, the computing system 200 generally includes a user computing device 210, a plurality of advertising networks (i.e., network domains that are configured to serve advertisements) 212A, 212B, 212C, 212D (which may each include one or more advertisement databases, as shown) and a data repository 214, all in communication with one another via a network 216. The network 216 may include, without limitation, one or more local area networks (LANs) and/or wide area networks (WANs). Such networking environments are commonplace in offices, enterprise-wide computer networks, intranets and the Internet. Accordingly, the network 216 is not further described herein.

It should be understood that any number of user computing devices and advertising networks may be employed in the computing system 200 within the scope of embodiments of the present invention. Each may comprise a single device/interface or multiple devices/interfaces cooperating in a distributed environment. For instance, one or more of the advertising networks 212A, 212B, 212C, 212D may comprise multiple devices and/or modules arranged in a distributed environment that collectively provide the functionality of the advertising networks 212A, 212B, 212C, 212D described herein. Additionally, other components/modules not shown may also be included within the computing system 200.

In some embodiments, one or more of the illustrated components/modules may be implemented as stand-alone applications. In other embodiments, one or more of the illustrated components/modules may be implemented via the user computing device 210, as an Internet-based service, or as a module inside one or more of the advertising networks 212A, 212B, 212C, 212D. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of servers or user computing devices. By way of example only, components (e.g., advertisement databases) of one or more of the advertising networks 212A, 212B, 212C, 212D might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The user computing device 210 may include any type of computing device, such as computing device 100 described with reference to FIG. 1, for example. As illustrated, the user computing device 210 includes a browser 218 and a display 220. As more fully described below, the browser 218 is configured to receive input of advertisement targeting preferences from a plurality of users and to present targeted (and non-targeted) advertisements in association with a display 220 of the user computing device 210. The browser 218 is further configured to add or append user-configured advertisement preferences to communication packets to be transmitted to network domains that serve advertisements, as more fully described below, and to transmit such communication packets. It will be understood by those of ordinary skill in the art that much of the functionality described herein as being performed by the browser 218 may be performed by any other application capable of rendering web content. Any and all such variations, and any combination thereof, are contemplated to be within the scope of embodiments of the present invention.

As previously stated, the browser 218 is configured to receive input of advertisement targeting preferences from a plurality of users in association with a display 220 of the user computing device 210. In embodiments, such advertisement targeting preferences may be configured by a user via a graphical user interface. Embodiments of graphical user interfaces for receiving user-configured advertisement targeting preference data may include a limited number of interests for a user to configure on the browser via check box selection or the like. The graphical user interface may be accessible on a new tab in the browser, via the browser options mode, via a local hosted webpage, or any other sort of user interface which conveniently allows users to express their commercial interests. In embodiments, users may be provided a “non-targeted advertisements” option (shown in FIG. 2 as ON•OFF control 224) which will generally not opt the user out of being presented with advertisements but will render the presented advertisements more generic, and thus presumably of less value. In embodiments, if a user desires to receive non-targeted advertisements only temporarily, opting back in to receiving targeted advertisements may be achieved through the same unified graphical user interface for a plurality of advertisement-serving domains and the user's previous history may be preserved. In embodiments, each browser manufacturer may be able to implement their own user interface for collecting advertisement targeting preference data configured by users.

Advertisement targeting preference data may include, by way of example only, demographic information such as country, city, gender, age, etc.; topics of interest (e.g., basketball, NIKE, HUGO BOSS); preferred advertising formats (e.g., image, video, text, coupons, etc.) and perhaps even such things as income range. Imagination and the network domain's ability to target is really the limit. In embodiments, the browser 218 may automatically populate the last X search queries (e.g., fifty) or the last X websites visited (e.g., twenty). In embodiments the browser 218 may capture the last few commercial objects viewed by the user. The type of content present in the user interface for collecting advertisement targeting preference data is essentially any information advertisers need to find the right audience for one or more advertisements they wish to serve. Similarly, the user interface for collecting advertisement preference data should resonate with the user and make them want to provide the requested information so that they are presented relevant and targeted advertisements. Users are likely to be unwilling to provide information unless they understand how providing the information might improve the relevance of the advertisements with which they are presented.

In embodiments, the user-configured advertisement preference data may be stored on disk or on local device storage 222. In such embodiments, users do not need to configure their advertisement targeting preferences each and every time the browser 218 is used. Rather, whenever the browser is started, it reads from the local storage 222 to fetch the user-configured advertisement-preference data. In other embodiments, the user-configured advertisement preferences may be stored on cloud storage 214, e.g., Windows Live SkyDrive®. With cloud storage, the advertisement preferences can be downloaded on the browser 218 across multiple devices such as PCs, tablets, smartphones, televisions, and the like. Any and all such storage options, and any combination thereof, are contemplated to be within the scope of embodiments hereof. In embodiments, the advertisement targeting preference data may be stored in cloud storage 214 and retrieved temporarily if the user is logged into a particular account or application so that their interest roams with them online.

In embodiments, advertisement targeting preference data is stored in a schema that is easy to understand and also is easy to be saved in a confined and/or compressed manner. This could be, for instance, XML or JSON. The schema in which the data is stored should be designed such that it can be extensible as future advertisers may request different information. An exemplary XML format is provided below:

<?xml version=”1.0”?>
<useradpreferences>
<demographic id=”CZAGL”>
<age>28</age>
<gender>male</gender>
<zip>98033</zip>
<language>English</language>
<birthday>1982-10-01</birthday>
...
</demographic>
<interests id=“LOCATION”>
<city>seattle</city>
<city>kirkland</city>
<city>portland</city>
</interests>
<interests id=”BRAND”>
<brand>hugo box</brand>
<brand>nike</brand>
<brand>xbox 360</brand>
<brand>Nordstrom</brand>
<brand>Honda</brand>
</interests>
<adtype id=“PRESENTATION”>
<adtype>video</adtype>
<adtype>coupons</adtype>
</adtype>

As shown above, the advertisement targeting preference data is organized in such a way that any network domain that serves advertisements can easily parse the information and provide the most relevant and targeted advertisements possible to the user.

The expectation for the user after making the advertisement preference selections is that they are presented with relevant advertisements. For this to happen, the browser 218, upon receiving a request for an advertisement, is configured to transmit the advertisement-preference data to network domains 212A, 212B, 212C, 212D that serve advertisements and, accordingly, the network domains 212A, 212B, 212C, 212D are configured to receive the advertisement requests. While it is possible for the browser 218 to transmit the advertisement-preference data with every single pack that it forwards, such action is inefficient. A more efficient way is to send the information only to those network domains that will use the information to serve advertisements. In order to do so, the browser 218 needs to know when a received request for online information is a request for an advertisement. The browser 218 may accomplish this in a number of different ways, within the scope of embodiments hereof.

In one embodiment, the browser 218 may simply have a list of network domains known to be domains that serve advertisements. These domains may include those that serve advertisement content itself (e.g., flash, image, video, etc.) or sites that gather advertisements from other services and deliver as page content (e.g., Bing® or Google® search results). Building a list of such network domains is fairly straight forward as there are only a limited number of advertisement network domains. Additionally, a new network domain that serves advertisements has an interest in notifying the browsers of its domain so that it will have access to the user-configured advertisement-preference data.

In another embodiment, advertisements may be served via an advertisement-oriented, standardized network protocol similar to HTTP. By way of example only, such a network protocol may be “HTTPAD://” or “AD://” or the like. It will be understood and appreciated by those of ordinary skill in the art that any number of ways in which a browser may determine whether a received request for online information is a request for an advertisement. Any and all such variations, and any combinations thereof, are contemplated to be within the scope of embodiments hereof.

Once the browser 218 is aware of which online information requests to transmit to network domains that serve advertisements 212A, 212B, 212C, 212D (that is, which online information requests are requests for advertisements), it is configured to automatically add or append the user-configured advertisement-preference data to the communication packet it sends transmitting the advertisement request. This can be done in a number of different ways within the scope of embodiments hereof. In one embodiment, the XML data may be added to the Uniform Resource Locator (URL) address of the advertisement request. In embodiments, the XML data may be added as parameters. This method does not require advertisements to be served off of a unique protocol. By way of example, if the URL address of an advertisement request is “http://adserver.com/publisher123/getad.aspx?adunitid=123,” with the user-configured advertisement-preference data added, the URL may become, e.g., “http://adserver.com/publisher123/getad.aspx?adunitid=123&adpreference=28|male|98033|englis h|1982-10-01\ . . . ” One advantage of this method is that it is compatible with network domains that serve advertisements today. One disadvantage may be a limitation on the maximum length of the URL.

In another embodiment, the XML data may be added in the UserAgent string of the browser 218. In accordance with HTTP standards, the browser 218 can send in a UserAgent string that describes the user's browser version and operating system environments. For instance, the UserAgent string “Mozilla/5.0 (compatible; MSIE 9.0; Windows NT 6.1; WOW64; Trident/5.0),” with the user-configured advertisement-preference data added, may become, e.g., “Mozila/5.0 (compatible; MSIE 9.0; Windows NT 6.1; WOW64; Trident/5.0; adpreference=28|male|98033|English| . . . ).” One advantage of this method is that it is compatible with network domains that serve advertisements today. Also, it does not take up the address URL space and is invisible to the user. However, there may be space limitations in the UserAgent string.

In another embodiment, there may be a universal cookie that the browser 218 is configured to transmit to network domains that serve advertisements, regardless of the domain. Generally, cookies are specific to particular domains and HTTP protocol states that when requesting a message from the domain, the cookie is to be appended to the Web request. In such a sense, a universal cookie would be a cookie that would be sent to all domains. Receiving domains would not be required to consume the cookie but they could if they chose to. One advantage of this method is that the sending of user-configured advertisement preference data may be achieved without any space limitations or displaying the large chunk of preference information to the user.

In another embodiment, and as previously set forth, a new Web protocol may be established, such as, e.g., “HTTPAD://” or “AD://.” Essentially, this embodiment would provide an entirely new Web protocol focused around advertisement serving. In such a case, information such as user-configured advertisement preference data may be built into the protocol itself.

It will be understood and appreciated by those of ordinary skill in the art that the delineated methods of adding user-configured advertisement-preference data to a communication packet containing an advertisement request are provided by way of example only. Any and all variations, and any combination thereof, are contemplated to be within the scope of embodiments of the present invention.

Thus, in accordance with embodiments hereof, network domains that serve advertisements 212A, 212B, 212C, 212D, when receiving a request for an advertisement from the browser 218, have access to the user-configured advertisement-preference data. As such, the network domains 212A, 212B, 212C, 212D are able to leverage that information in delivering relevant and targeted advertisements to the user. There may be cases in which the user-configured advertisement preference data may differ from preference data a particular network domain already has collected for a particular user. In such a case, the network domain may respect the user-configured advertisement-preference data provided by the browser 218, prioritize their own data above the browser-provided data, or any combination thereof.

Once a targeted advertisement is selected, the network domains 212A, 212B, 212C, 212D are configured to transmit the selected advertisement(s) to the browser 218 for presentation. Accordingly, the browser 218 is also configured to receive at least one advertisement targeted in accordance with the user-configured advertisement-preference data from one of the network domains that serves advertisements 212A, 212B, 212C, 212D and to present the targeted advertisement to the user, for instance, utilizing display 220.

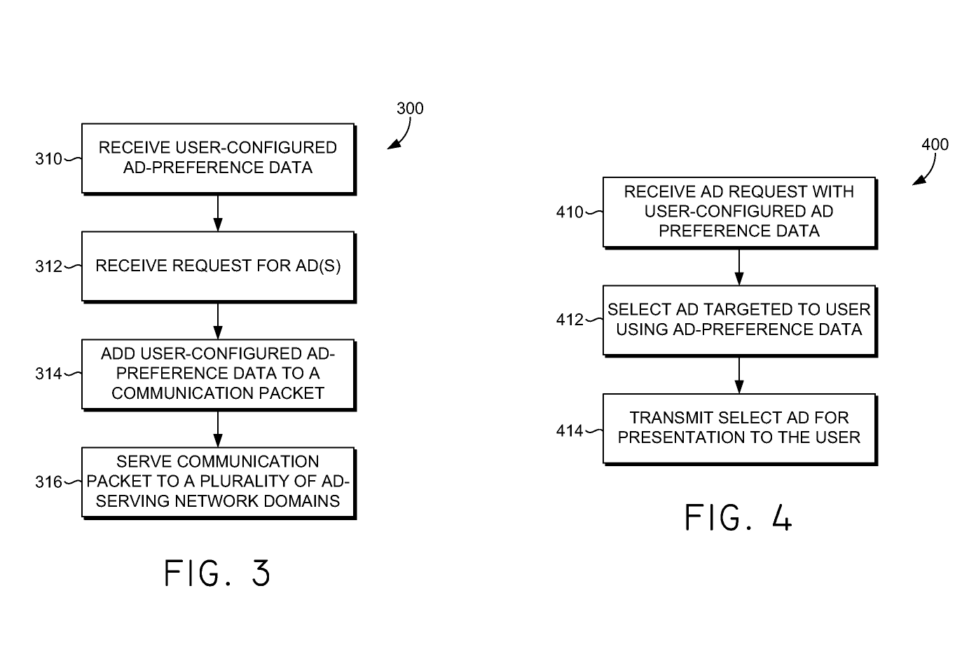

Turning now to FIG. 3, a flow diagram is provided that illustrates a method 300 for communicating user-configured advertisement preferences to a plurality of network domains that serve advertisements, in accordance with an embodiment of the present invention. As indicated at block 310, user-configured advertisement targeting preference data is received by a plurality of network domains for selecting targeted advertisements. In embodiments, such data is input by the user to the browser (e.g., browser 218 of FIG. 2) via a unified user interface through use of a display (e.g., display 220 of the client device 210 of FIG. 2). As indicated at block 312, a request for an advertisement is received. In embodiments, such request is received from a user via the user's browser (e.g., browser 218 of FIG. 2).

As indicated at block 314, the user-configured advertisement-preference data is added or appended to a communication packet that will be transmitted, for instance, from the browser (e.g., browser 218 of FIG. 2) to a plurality of network domains that serve advertisements (e.g., network domains 212A, 212B, 212C, 212D of FIG. 2). As indicated at block 316, the communication packet having the user-configured advertisement-preference data added thereto is then served to at least a portion of the plurality of network domains that serve advertisements in response to the advertisement request.

With reference to FIG. 4, a flow diagram is provided that illustrates a method 400 for presenting targeted advertisements to online users, in accordance with an embodiment of the present invention. As indicated at block 410, a request for an advertisement is received, for instance by one or more network domains configured for serving advertisements (e.g., advertising networks 212A, 212B, 212C, 212D of FIG. 2). The advertisement request received includes advertisement-preference data configured by a user. As indicated at block 412, at least one advertisement targeted to the user based upon the received advertisement-preference data is selected. The selected advertisement(s) are then transmitted (e.g., from the advertisement networks 212A, 212B, 212C, 212D to the browser 218 of FIG. 2) for presentation to the user.

As can be understood, embodiments of the present invention provide systems and methods for communicating advertisement preferences configured by users via a unified interface to a plurality of network domains that serve advertisements. Embodiments of the present invention positively synergize the user-advertiser-advertising network system. Network domains that serve advertisements are able to be less focused on capturing user behavior data but rather more on ensuring that the advertisement targeting preferences specified by users are respected. Advertisers can also find the users they want to target with fewer false positives and focus more on delivering the right marketing message and advertisement content to the right set of audiences. Further, users are empowered to express themselves of interests, demographics, and the like, for being presented with significantly better advertisements throughout their Internet experience. Additionally, users have the ability to opt-out of receiving targeted advertisements from a plurality of network domains that serve advertisements via a single unified interface. And, if a user desires to opt-out only temporarily, opting back in may be achieved through a single unified interface for a plurality of advertisement-serving domains and with the user's previous history preserved

The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the method 300 of FIG. 3 and the method 400 of FIG. 4 are not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. One or more computer-readable storage media storing computer-useable instructions that, when used by one or more computing devices, cause the one or more computing devices to perform a method for communicating user-configured advertisement preferences to a plurality of network domains that serve advertisements, the method comprising:
receiving user-configured advertisement-preference data configured for use by the plurality of network domains for selecting targeted advertisements;
receiving a request for an advertisement;
automatically adding the user-configured advertisement-preference data to a communication packet; and
serving the communication packet with the user-configured advertisement-preference data added thereto to at least a portion of the plurality of network domains in response to the advertisement request.

2. The one or more computer-readable storage media of claim 1, further comprising:
receiving at least one advertisement targeted in accordance with the user-configured advertisement-preference data from one of the plurality of network domains that serves advertisements; and
presenting the targeted advertisement.

3. The one or more computer-readable storage media of claim 1, wherein the user-configured advertisement preference data is stored locally on a client device.

4. The one or more computer-readable storage media of claim 1, wherein the user-configured advertisement preference data is stored on cloud storage.

5. The one or more computer-readable storage media of claim 1, wherein receiving the request for the advertisement comprises receiving a request for online information and determining that the online information request is an advertisement request.

6. The one or more computer-readable storage media of claim 5, wherein determining that the online information request is an advertisement request comprises determining that the online information request corresponds to a domain known to be one or the plurality of network domains that serves advertisements.

7. The one or more computer-readable storage media of claim 5, wherein determining that the online information request is an advertisement request comprises determining that the online information request is received via an advertisement-oriented, standardized network protocol.

8. The one or more computer-readable storage media of claim 1, wherein automatically adding the user-configured advertisement-preference data to a communication packet comprises adding the user-configured advertisement-preference data to the Uniform Resource Location address of the advertisement request.

9. The one or more computer-readable storage media of claim 1, wherein automatically adding the user-configured advertisement-preference data to a communication packet comprises adding the user-configured advertisement-preference data to the browser UserAgent string.

10. The one or more computer-readable storage media of claim 1, wherein automatically adding the user-configured advertisement-preference data to a communication packet comprises adding the user-configured advertisement-preference data via a domain-independent universal cookie.

11. One or more computer-readable storage media storing computer-useable instructions that, when used by one or more computing devices, cause the one or more computing devices to perform a method for presenting targeted advertisements to online users, the method comprising:
receiving a request for an advertisement, the request including advertisement-preference data configured by a user;
selecting at least one advertisement targeted to the user utilizing the advertisement-preference data; and
transmitting the selected at least one advertisement for presentation to the user.

12. The one or more computer-readable storage media of claim 11, wherein the advertisement request is received via an advertisement-oriented, standardized network protocol that includes the user-configured advertisement-preference data.

13. The one or more computer-readable storage media of claim 11, wherein the user-configured advertisement-preference data is appended to the Uniform Resource Location address of the advertisement request.

14. The one or more computer-readable storage media of claim 11, wherein the user-configured advertisement-preference data is appended to the browser UserAgent string.

15. The one or more computer-readable storage media of claim 11, wherein the user-configured advertisement-preference data is received via a domain-independent universal cookie.

16. A unified advertisement targeting system configured for use by a plurality of network domains that serve advertisements, the system comprising:
a computing device associated with one or more processors and one or more computer-readable storage media;
a data store coupled with the computing device; and
a browser, wherein the browser is configured to:
receive user-configured advertisement-preference data configured for use by the plurality of network domains for selecting targeted advertisements;
receive a request for an advertisement;
automatically add the user-configured advertisement-preference data to a communication packet;
serve the communication packet with the user-configured advertisement-preference data added thereto to at least a portion of the plurality of network domains in response to the advertisement request;
receive at least one advertisement targeted in accordance with the user-configured advertisement-preference data from one of the plurality of network domains that serves advertisements; and
present the targeted advertisement.

17. The advertisement targeting system of claim 16, wherein the advertisement request is received via an advertisement-oriented, standardized network protocol that includes the user-configured advertisement-preference data.

18. The advertisement targeting system of claim 16, wherein the user-configured advertisement-preference data is appended to the Uniform Resource Location address of the advertisement request.

19. The advertisement targeting system of claim 16, wherein the user-configured advertisement-preference data is appended to the browser UserAgent string.

20. The advertisement targeting system of claim 16, wherein the user-configured advertisement-preference data is received via a domain-independent universal cookie.
